(19) United States
(12) Patent Application Publication
(10) Pub. No.: US 2005/0039644 A1
(43) Pub. Date: Feb. 24, 2005

(54) Modular workbench

(76) Inventors: Kevin Patrick Sheahan, Colorado Springs, CO (US); Thomas Alan Bulk, Colorado Springs, CO (US)

Correspondence Address: KEVIN SHEAHAN, 3531 E. MANSO ST., PHOENIX, AZ, 85044, US

(21) Appl. No.: 10/643,142

(22) Filed: Aug. 18, 2003

(51) Int. Cl. A47B 5/00; B25H 1/00

(52) U.S. Cl. 108/152

(57) ABSTRACT

A modular workbench assembly is presented that provides the user with an infinite number of potential workbench configurations with varying quantities of lower shelf sets, drawer sets, and upper shelf sets. This invention allows economical continual workbench lengthwise expansion by featuring a unique leg assembly and a unique upper shelf assembly that permit a specified number of dimensional lumber pieces to span and fasten to its top surface, or allows the fastening of twice as many dimensional lumber pieces forming a butt joint at the central vertical axis of both the leg assembly and the upper shelf assembly. The leg vertical member of U-shaped cross section features a pair of outward and opposite lengthwise protruding flanges and features a pair of adjacent lateral mounting surfaces so that lateral members, lengthwise members and upward members can be installed simultaneously using a unique, common interlocking fastening scheme which prevents the members from becoming loose under a vibration environment. A unique upper shelf assembly is presented that snaps into place on a leg assembly and is fully adjustable. The upper shelf assembly permits installation of additional structural members onto the leg assembly without removal of the upper shelf assembly from the leg assembly. A universal drawer rail assembly is presented that enables quick and sturdy assembly that is fully interchangeable as either a left drawer rail or a right drawer rail.

### CROSS-REFERENCE TO RELATED APPLICATIONS

Reference U.S. patent application Ser. No. 09/775,753 entitled Workbench filed pro se Feb. 5, 2001. Referenced patent addresses the leg's ability to accept a specified quantity of dimensional lumber pieces spanning its top surface or accepts the fastening of twice as many dimensional lumber pieces forming a butt joint at the central vertical axis of the leg assembly.

### FEDERAL SPONSORED RESEARCH OR DEVELOPMENT

This invention is not related in any means to any federal sponsored research or development.

### BACKGROUND OF THE INVENTION

A modular workbench assembly is presented that provides the user with an infinite number of potential workbench configurations with varying quantities of lower shelf sets, drawer sets, and upper shelf sets.

Prior art modular workbenches do not permit continual lengthwise expansion of the workbench primary working surface and do not permit continual lengthwise expansion of the upper shelf holding surface. By specifying a length of the primary working surface and length of the upper shelf holding surface, prior art restricts the user to a workbench configuration of predetermined length, and in turn limits the user to predetermined quantities of lower shelf sets, drawer sets, and upper shelf sets.

This invention allows continual workbench lengthwise expansion by featuring a unique leg assembly and a unique upper shelf assembly both of which utilize nested members of U-shaped cross section with pairs of outward protruding flanges, and are fastened at their interface. Localized cutouts are incorporated into the leg vertical member to enable nesting with the leg horizontal member. Likewise, localized cutouts are incorporated into the shelf horizontal member to enable nesting into the shelf vertical member. This leg assembly design and upper shelf assembly design were chosen to utilize the economical metal roll forming fabrication process. Both the leg assembly and upper shelf assembly provide a top surface sized in length to permit a specified number of dimensional lumber pieces to span and fasten to it, or allows the fastening of twice as many dimensional lumber pieces forming a butt joint at the central vertical axis of both the leg assembly and the upper shelf assembly. This concept of a workbench design that enables continual lengthwise expansion utilizing butted joints of dimensional lumber pieces centered on a leg assembly and upper shelf bracket is new to the industry. In accordance with document entitled “History of Yard Lumber Size Standards” dated September 1964 and issued by the U.S. Department of Agriculture, standardized lumber widths were first established in 1924. Workbench patents prior to this 1924 date could not have considered designing their leg assemblies and upper shelf brackets components to incorporate a butt joint to accommodate a specified quantity of same width dimensional lumber pieces since this standardized lumber did not exist.

Nesting of the leg horizontal member and leg vertical member permits small packaging of the unassembled leg components and minimizes shipping costs. Likewise, nesting of the shelf horizontal member and shelf vertical member permits small packaging of the unassembled upper shelf components and minimizes shipping costs. Small packages enable a new kitted workbench concept where primary assemblies such as a leg assembly or upper shelf assembly or lower shelf assembly can be sold as a unit permitting the user the freedom to create his own workbench with unspecified quantities of lower shelf sets, drawer sets, and upper shelf sets.

The following patents were reviewed to ensure the use of nested members of U-shaped cross section with pairs of outward protruding flanges was new:

| | | |
|---|---|---|
| #1,379,623 | dated May 1921 | Hallowell |
| #4,408,642 | dated October 1983 | Jeruzal, et al. |
| #4,846,453 | dated July 1989 | Salotto |
| #4,883,246 | dated November 1989 | Esposito |
| #5,016,765 | dated May 1991 | Leonardo |
| #6,047,750 | dated April 2000 | Jensen |
| #6,283,250 | dated September 2001 | Asher |
| #6,299,152 | dated October 2001 | Sangmeister, et al. |
| #6,318,713 | dated November 2001 | Levi |
| #6,347,592 | dated February 2002 | Gessert |

Prior art restricted the user to an upper shelf assembly that was not fully adjustable in height, as lower shelf horizontal members would interfere with the fastening of the upper shelf vertical member. This invention overcomes that limitation through the use of permanent spacer rivets installed on the shelf vertical member in combination with long shoulder rivets resulting in a gap at installation between the leg vertical member and the upper shelf vertical member, whereby the lower shelf horizontal members can be assembled and disassembled without the need to remove the upper shelf vertical member.

Prior art consists of complicated drawer rail assemblies that are costly, difficult to install, are prone to fatigue failure over time, and are designated as either a right rail or left rail, but not both. One such complicated prior art example is U.S. Pat. No. 6,015,053 dated January 2000 by Sheng where a rail is attached to a shelf member using complicated plugs and sockets. This invention overcomes complicated prior art by providing a universal rail assembly that is simple, rugged, equipped with drawer stops, and can be used on either the right or left side of the drawer. The rail assembly describes in this invention mates to the leg assembly with a common shoulder rivet to teardrop shaped hole interface. The rail assembly is metal and the drawer is plastic. The drawer interfaces with the rail assembly at a drawer lip that is nearly hollow, but webbed, to minimize material contact and reduce surface friction when the drawer slides on the rail. The materials of the rail and drawer were selected to provide minimal surface friction during opening and closing of the drawer. The rail assembly incorporates a unique channel that when installed, the top surface overlaps the lip of the drawer in its entirety enabling pins to be installed through this top surface acting as both an outward and inward drawer stop.

The following patents were reviewed to ensure the design of this rail assembly was new:

| | | |
|---|---|---|
| #3,099,501 | dated July 1963 | Etal |
| #3,911,835 | dated October 1975 | Schill |
| #4,121,878 | dated October 1978 | Lokken |
| #4,274,689 | dated June 1981 | Van der Ley et al. |
| #4,579,402 | dated April 1986 | Wenzlick et al. |
| #4,653,937 | dated March 1987 | Lautenschlager, Jr. |
| #4,732,436 | dated March 1988 | Nelson |
| #4,804,239 | dated February 1989 | Rock et al. |
| #5,020,869 | dated June 1991 | Faust |
| #5,685,622 | dated November 1997 | Laakso |

### BRIEF SUMMARY OF INVENTION

A modular workbench assembly is presented that provides the user with an infinite number of potential workbench configurations ranging from a simple two legged workbench for a user with limited space, to a continuous workbench system comprising of a continuous primary working surface and a continuous upper shelf storage surface with a large quantity of legs for spanning the length of a large production facility. An infinite number of potential workbench configurations is possible with varying quantity of lower shelf sets, drawer sets and upper shelf sets.

This invention allows continual workbench lengthwise expansion by featuring a unique leg assembly and a unique upper shelf assembly both of which utilize nested members of U-shaped cross section with pairs of outward protruding flanges, and are fastened at their interface. Localized cutouts are incorporated into the leg vertical member to enable nesting with the leg horizontal member. Likewise, localized cutouts are incorporated into the shelf horizontal member to enable nesting into the shelf vertical member. This leg assembly design and upper shelf assembly design were chosen to utilize the economical metal roll forming fabrication process. Both the leg assembly and upper shelf assembly provide a top surface sized in length to permit a specified number of dimensional lumber pieces to span and fasten to it, or allows the fastening of twice as many dimensional lumber pieces forming a butt joint at the central vertical axis of the leg assembly and upper shelf assembly. This concept provides an economical means to create a workbench with a smooth, continuous, expandable working surface and upper shelf holding surface.

Nesting of the leg horizontal member and leg vertical member permits small packaging of the unassembled leg components and minimizes shipping costs. Likewise, nesting of the shelf horizontal member and shelf vertical member permits small packaging of the unassembled upper shelf components and minimizes shipping costs. Small packages enable a new kitted workbench concept where primary assemblies such as a leg assembly or upper shelf assembly or lower shelf assembly can be sold as a unit permitting the user the freedom to create his own workbench with unspecified quantities of lower shelf sets, drawer sets, and upper shelf sets.

The leg vertical member of U-shaped cross section features a pair of outward and opposite lengthwise protruding flanges and features a pair of adjacent lateral mounting surfaces so that lateral members, length-wise members and upward members can be installed simultaneously using a unique, common interlocking fastening scheme which prevents the members from becoming loose under a vibration environment. The adjacent lateral mounting surfaces of the leg vertical member are identical and have been designed to accept either a bracket for mounting a shelf, or a channel assembly for installing a drawer; both of which contain a common interlocking fastening scheme. The outward facing flanged surfaces of the leg vertical member are identical and have been designed to accept a shelf bracket with the same interlocking fastening scheme.

This invention provides a simple-to-install upper shelf assembly that is fully adjustable in height. Permanent spacer are installed on the shelf vertical member in combination with long shoulder rivets resulting in a gap at installation between the leg vertical member and the shelf vertical member whereby the lower shelf horizontal members can be assembled and disassembled without the need to remove the shelf vertical member.

The upper shelf vertical member of U-shaped cross section with a pair of outward protruding flanges, provides two adjacent lateral surfaces to permit the fastening of an upper shelf horizontal member at varying heights, and provides two outward facing flanged surfaces so that length-wise members can be installed using the same interlocking fastening scheme which prevents the members from becoming loose under a vibration environment.

This invention provides a universal rail assembly that is simple, rugged, equipped with drawer stops, and can be used on either the right or left side of the drawer. The rail assembly describes in this invention mates to the leg assembly with the proven shoulder rivet to teardrop shaped hole interface. The rail assembly is metal and the drawer is plastic. The drawer interfaces with the rail assembly at a drawer lip that is nearly hollow, but webbed, to minimize material contact and reduce surface friction when the drawer slides on the rail. The materials of the rail and drawer were selected to provide minimal surface friction during opening and closing of the drawer. The rail assembly incorporates a unique channel when once installed, the top surface overlap the lip of the drawer in its entirety enabling pins to be installed through this top surface acting as both an outward and inward drawer stop.

This concept provides the user with the option of creating a workbench of any length comprising of a continuous primary working surface utilizing butted dimensional lumber pieces, and a continuous upper shelf storage surface utilizing butted dimensional lumber pieces, and accommodates a varying quantity of lower shelf sets, drawer sets and upper shelf sets.

### BRIEF DESCRIPTION OF THE DRAWINGS

The accompanying drawings illustrate preferred embodiments of the invention according to the practical application of the principles thereof and in which:

FIG. 1 is a perspective view of the structural members required for a workbench configuration of a single set of long shelves and a single set of drawers, an upper shelf, and brackets for holding three sets of small bins.

FIG. 2 is a perspective view of a completed workbench configuration of a single set of long shelves and a single set of drawers and a two-tier upper shelf.

FIG. 3 is a detail view of a pin in a rail assembly that is being used for an outward drawer stop as the drawer is in its full open position.

FIG. 4 is a perspective view of the bolted leg assembly.

FIG. 5 is an exploded view of the structural members shown in FIG. 4.

FIG. 6 is a perspective view of the leg horizontal member.

FIG. 7 is a perspective view of the leg vertical member.

FIG. 8 is another perspective view of the leg vertical member illustrating the cutout features.

FIG. 9 is a detail view showing the installation of the long bracket onto the leg vertical member outward facing mounting surface, and showing the installation of the short bracket onto the leg vertical member adjacent lateral mounting surface.

FIG. 10 is a detail view of the rail assembly installed onto the leg vertical member adjacent lateral mounting surface.

FIG. 11 is a perspective view of the upper shelf assembly.

FIG. 12 is a partial exploded view of the structural members depicted in FIG. 11.

FIG. 13 is a perspective view of the shelf horizontal member.

FIG. 14 is a perspective view of a completed workbench configuration of a single set of long shelves and a single set of drawers and an upper shelf with all but one dimensional lumber piece installed.

FIG. 15 is a perspective view of the shelf vertical member.

FIG. 16 is a partial exploded view of the shelf vertical member to leg vertical member installation.

FIG. 17 is a detail view of the shelf vertical member installed onto the leg vertical member depicting the clearance achieved between these two members for installation of a long bracket or short bracket.

FIG. 18 is a detail view looking downward from the top of the installed shelf vertical member shown in FIG. 17, and illustrates the function of the spacers in achieving a gap between the outward facing mounting surfaces of the leg vertical member and the outward facing mounting surfaces of the shelf vertical member, that in turn provides clearance for the installation and removal of the long brackets and short brackets.

FIG. 19 is a perspective view of the rail assembly.

FIG. 20 is a perspective view of the plastic injected drawer.

FIG. 21 is a perspective view of a completed workbench configuration of a single set of long shelves, and a set of drawers on each side of the set of long shelves, and a two-tier upper shelf.

FIG. 22 is a perspective view of a completed workbench configuration of a single set of long shelves and an upper shelf.

FIG. 23 is a perspective view of a completed workbench configuration of a single set of long shelves, a single set of short shelves, and a two-tier upper shelf.

FIG. 24 is a perspective view of the plastic injected drawer inserted into two rail assemblies.

FIG. 25 is a perspective view of a completed workbench configuration of a single set of long shelves and a single set of drawers, an upper shelf, three long brackets orientated to hold sets of small bins, and three short brackets orientated to hold sets of small bins.

FIG. 26 is a perspective view of a completed workbench configuration illustrating the structural members of FIG. 1 and including all lumber, plastic injected drawers and small bins.

FIG. 27 is a detail view of an installed short bracket on the shelf vertical member, orientated to hold small bins.

FIG. 28 is a detail view of an installed short bracket on the leg vertical member, orientated to support a long wooden shelf.

### DETAILED DESCRIPTION OF THE INVENTION

A modular workbench assembly is presented that provides the user with an infinite number of potential workbench configurations ranging from a simple two legged workbench for a user with limited space, to a continuous workbench system comprising of a continuous primary working surface and a continuous upper shelf storage surface with a large quantity of legs for spanning the length of a large production facility. An infinite number of potential workbench configurations is possible with varying quantity of lower shelf sets, drawer sets and upper shelf sets.

This invention allows continual workbench lengthwise expansion by featuring a unique leg assembly and a unique upper shelf assembly both of which utilize nested members of U-shaped cross section with pairs of outward protruding flanges, and are fastened at their interface. Localized cutouts are incorporated into the leg vertical member to enable nesting with the leg horizontal member. Likewise, localized cutouts are incorporated into the shelf horizontal member to enable nesting into the shelf vertical member. This leg assembly design and upper shelf assembly design were chosen to utilize the economical metal roll forming fabrication process. Both the leg assembly and upper shelf assembly provide a top surface sized in length to permit a specified number of dimensional lumber pieces to span and fasten to it, or allows the fastening of twice as many dimensional lumber pieces forming a butt joint at the central vertical axis of the leg assembly and upper shelf assembly.

Nesting of the leg horizontal member and leg vertical member permits small packaging of the unassembled leg components and minimizes shipping costs. Likewise, nesting of the shelf horizontal member and shelf vertical member permits small packaging of the unassembled upper shelf components and minimizes shipping costs. Small packages enable a new kitted workbench concept where primary assemblies such as a leg assembly or upper shelf assembly or shelf assembly can be sold as a unit permitting the user the freedom to create his own workbench with unspecified quantities of lower shelf sets, drawer sets, and upper shelf sets.

The leg vertical member of U-shaped cross section features a pair of outward and opposite lengthwise protruding flanges and features a pair of adjacent lateral mounting surfaces so that lateral members, length-wise members and upward members can be installed simultaneously using a unique, common interlocking fastening scheme which prevents the members from becoming loose under a vibration environment. The adjacent lateral mounting surfaces of the leg vertical member are identical and have been designed to accept either a bracket for mounting a shelf or a channel assembly for installing a drawer; both of which contain a common interlocking fastening scheme. The outward facing flanged surfaces of the leg vertical member are identical and have been designed to accept a shelf bracket with the same interlocking fastening scheme.

This invention provides a simple-to-install upper shelf assembly that is fully adjustable in height. Permanent spacers are installed on the shelf vertical member in combination with long shoulder rivets resulting in a gap at installation between the leg vertical member and the shelf vertical member whereby the lower shelf horizontal members can be assembled and disassembled without the need to remove the shelf vertical member.

The upper shelf vertical member of U-shaped cross section with a pair of outward protruding flanges, provides two adjacent lateral surfaces to permit the fastening of an upper shelf horizontal member at varying heights, and provides two outward facing flanged surfaces so that length-wise members can be installed using the same interlocking fastening scheme which prevents the members from becoming loose under a vibration environment.

This invention provides a universal rail assembly that is simple, rugged, equipped with drawer stops, and can be used on either the right or left side of the drawer. The rail assembly describes in this invention mates to the leg assembly with the proven shoulder rivet to teardrop shaped hole interface. The rail assembly is metal and the drawer is plastic. The drawer interfaces with the rail assembly at a drawer lip that is nearly hollow, but webbed, to minimize material contact and reduce surface friction when the drawer slides on the rail. The materials of the rail and drawer were selected to provide minimal surface friction during opening and closing of the drawer. The rail assembly incorporates a unique channel when once installed, the top surface overlaps the lip of the drawer in its entirety enabling pins to be installed through this top surface acting as both an outward and inward drawer stop.

The following description of the Figures is intended only by way of example and simply illustrates certain presently preferred embodiments consistent with the invention as claimed.

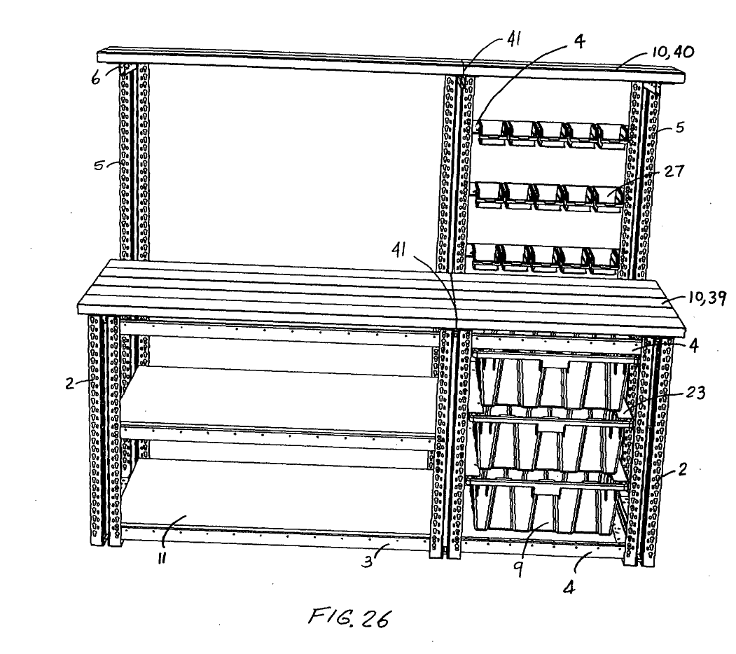

Referring to FIG. 26, the structure of one potential workbench configuration is presented with dimensional lumber pieces 10 fastened as the primary working surface 39, with dimensional lumber pieces 10 fastened as the upper shelf holding surface 40, with plywood panels fastened as long wooden shelves 11, with plastic drawers 9 installed, and with small bins 27 installed on the short brackets 4 that span between the two shelf vertical members 5. Lengthwise expansion of the primary working surface is depicted by butting the adjoining edges of the dimensional lumber pieces 10 and forming a butt joint 41 positioned over the centerline of the leg horizontal member 1. Lengthwise expansion of the upper shelf holding surface 40 is depicted by butting the adjoining edges of the dimensional lumber pieces 10 and forming a butt joint 41 positioned over the centerline of the shelf horizontal member 6.

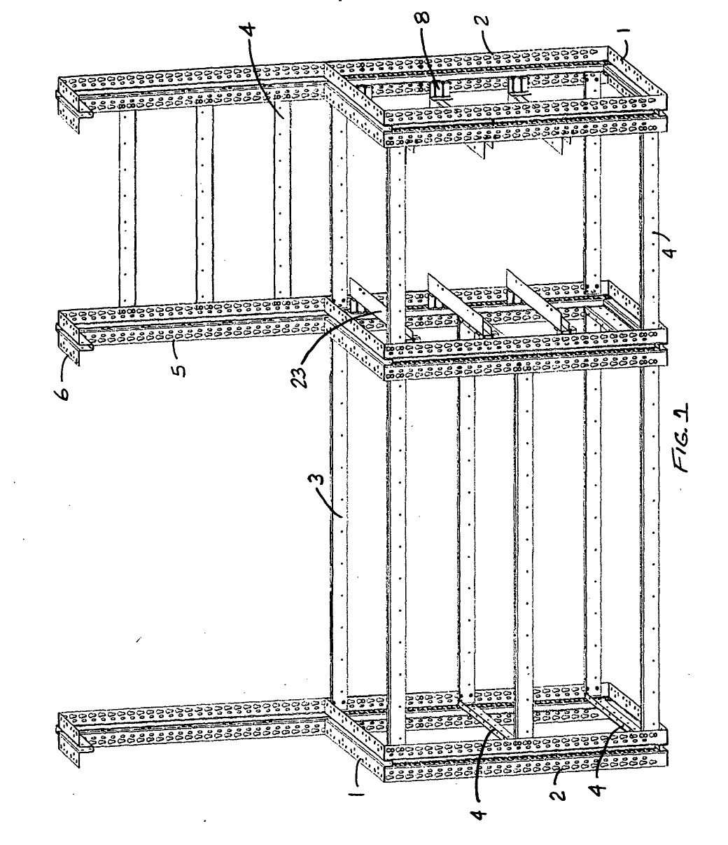

FIG. 1 depicts the same structural members as FIG. 26 but omits the dimensional lumber pieces 10 fastened as the primary working surface 39, omits the dimensional lumber pieces 10 fastened as the upper shelf holding surface 40, omits the plywood panels fastened as long wooden shelves 11, omits the plastic drawers 9, and omits the small bins 27 installed on the short brackets 4 that span between the two shelf vertical members 5.

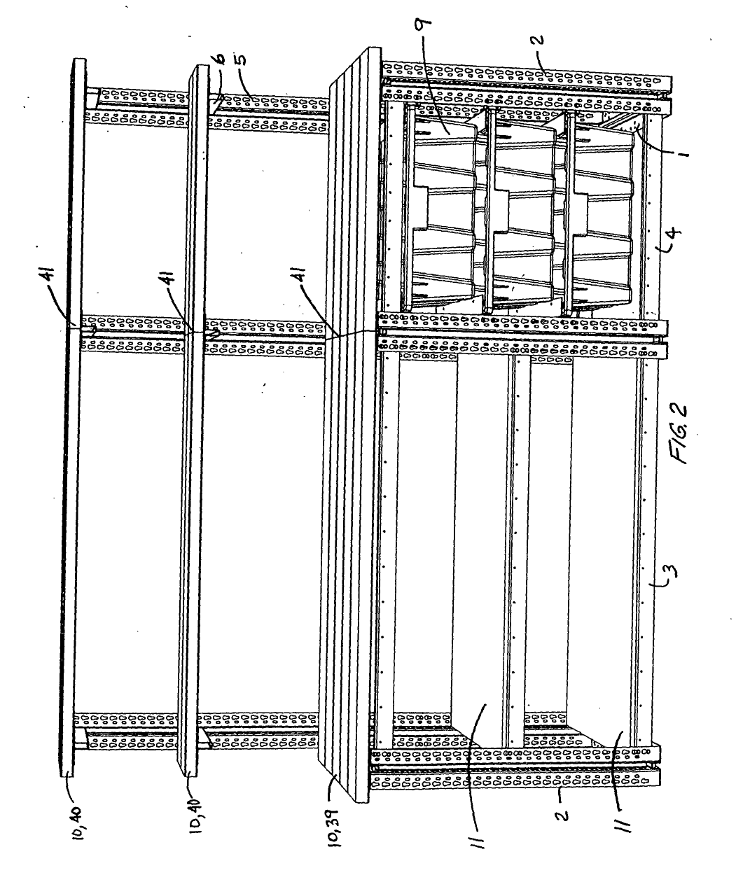

FIG. 2 depicts a similar potential workbench configuration as FIG. 1 but omits the short brackets 4 spanning between the two shelf vertical members 5, and includes a second set of dimensional lumber pieces 10 installed as a two-tier upper shelf. Lengthwise expansion of the primary working surface 39 and upper shelf holding surface 40 is depicted using butt joints 41.

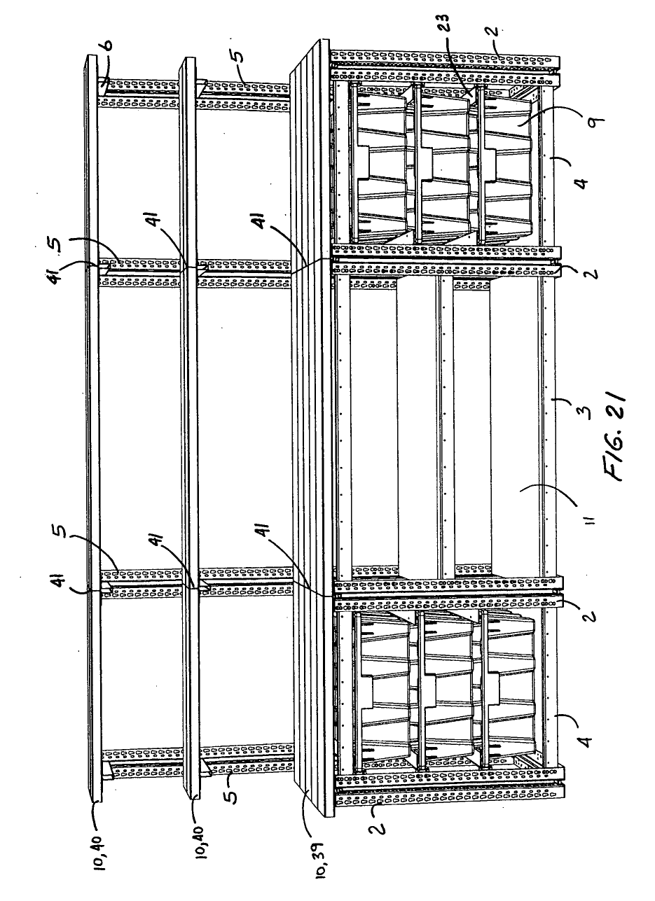

FIG. 21 illustrates a larger potential workbench configuration with two drawer 9 sets installed, and two upper shelf holding surfaces 40. Further lengthwise expansion of the workbench primary working surface 39 and upper shelf holding surface 40 is depicted using additional butt joints 41 when compared to FIG. 1 and FIG. 2.

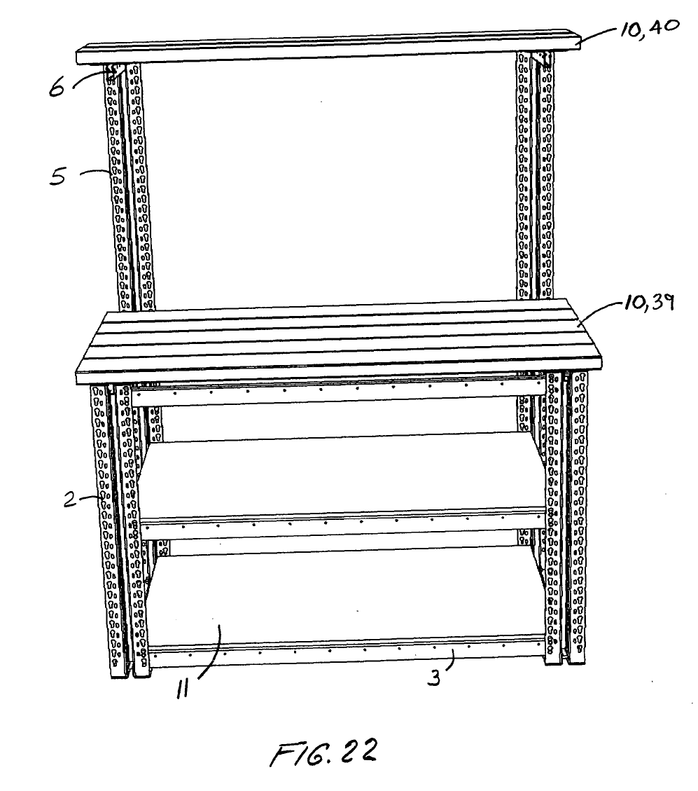

FIG. 22 illustrates a simple potential workbench configuration with a set on long wooden shelves 11 installed and a shortened primary working surface 39 and an upper shelf holding surface 40, both without butt joints 41.

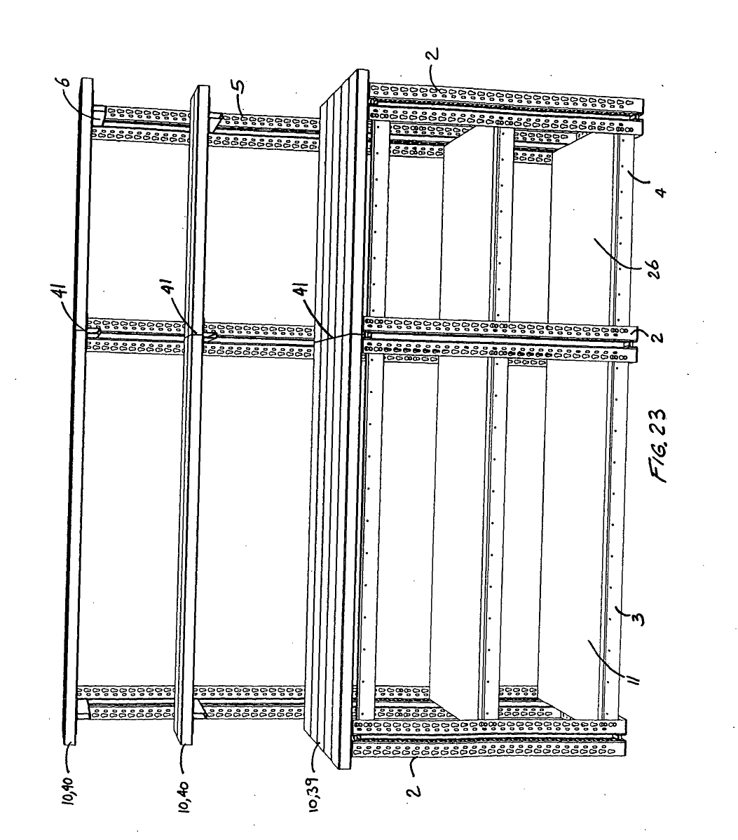

FIG. 23 depicts a potential workbench configuration utilizing a set of long wooden shelves 11, a set of short wooden shelves 26 and a two-tier upper shelf.

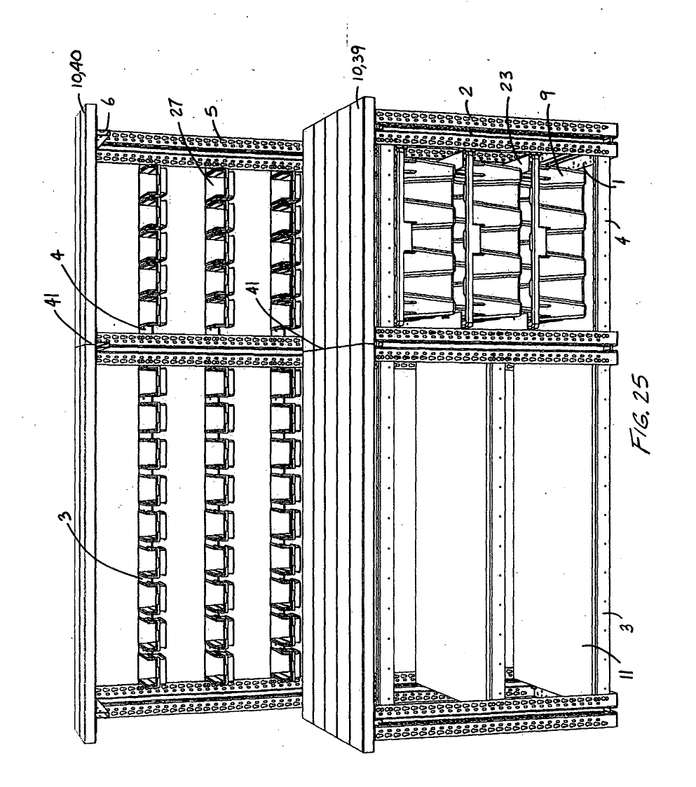

FIG. 25 depicts a potential workbench configuration utilizing a set of long wooden shelves 11, a set of drawers 9, a one-tier upper shelf, short brackets 4 spanning between two shelf vertical members 5 holding small bins 27, and long brackets 3 spanning between two shelf vertical members 5 holding small bins 27.

All metal members have been designed so that they may be manufactured using metal roll forming techniques.

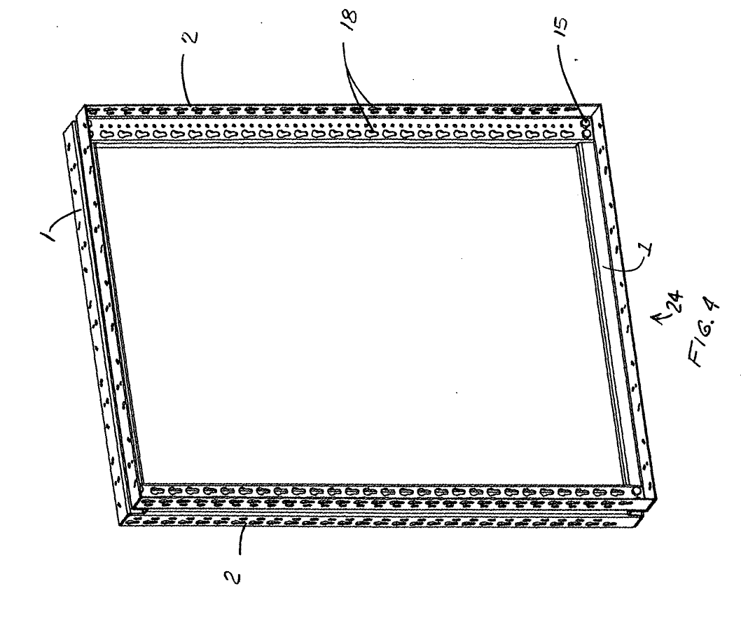

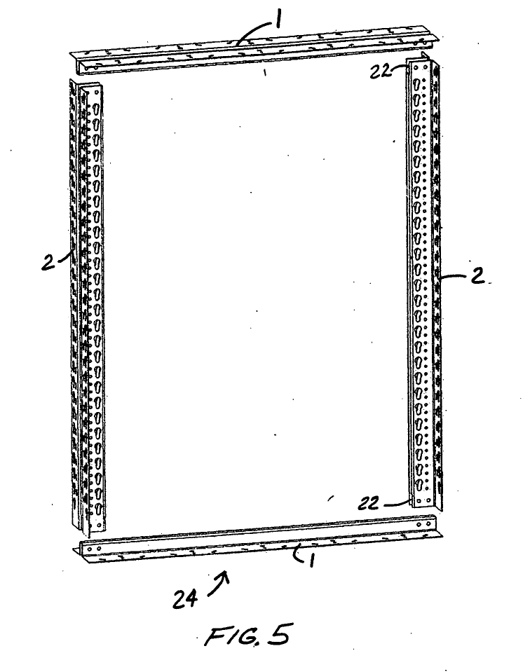

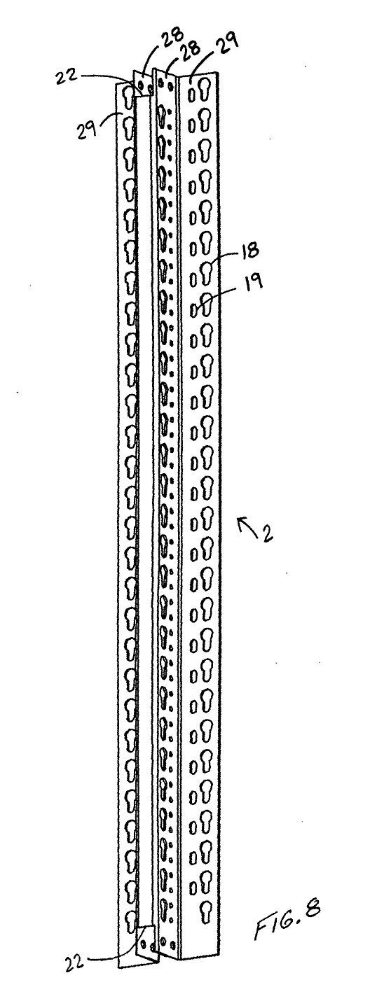

As detailed in FIG. 4, the leg assembly 24 is comprised of two leg horizontal members 1 and two leg vertical members 2 bolted together by a pair of bolts 15 at each corner. FIG. 5 is an exploded view of the leg assembly 24 illustrating how the leg horizontal members 1 are nested into cutouts 22 in the leg vertical members 2. FIG. 8 further depicts the cutouts 22 in the leg vertical member 2.

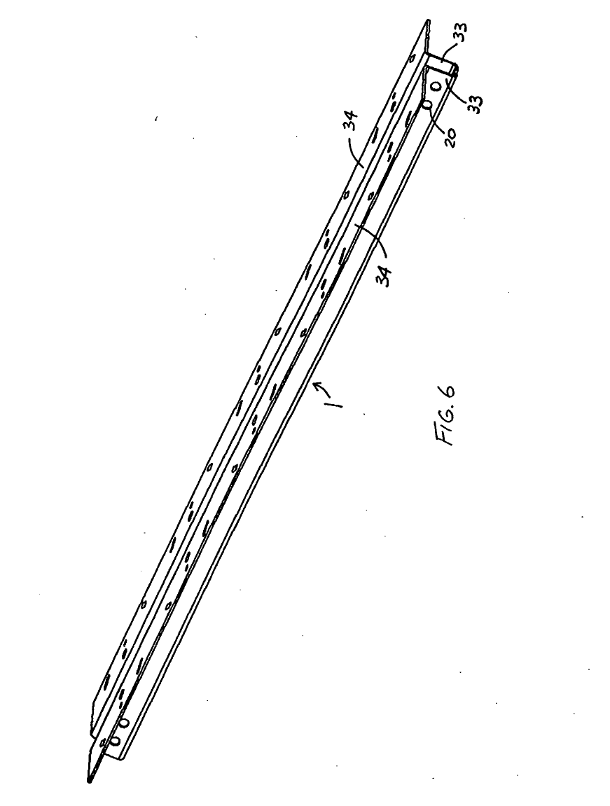

As illustrated in FIG. 6, the leg horizontal member 1 has a U-shaped cross section with a pair of outward facing mounting surfaces 34 with unique hole pattern and a pair of adjacent lateral surfaces 33. The leg horizontal member 1 is sized in length to accept the fastening of an integer number of dimensional lumber pieces 10 spanning its top surface or accepts the fastening of twice as many dimensional lumber pieces 10 forming a butt joint at the centerline of its cross section. Screws fasten the dimensional lumber pieces to the unique pattern of the leg horizontal member's outward facing mounting surfaces 34.

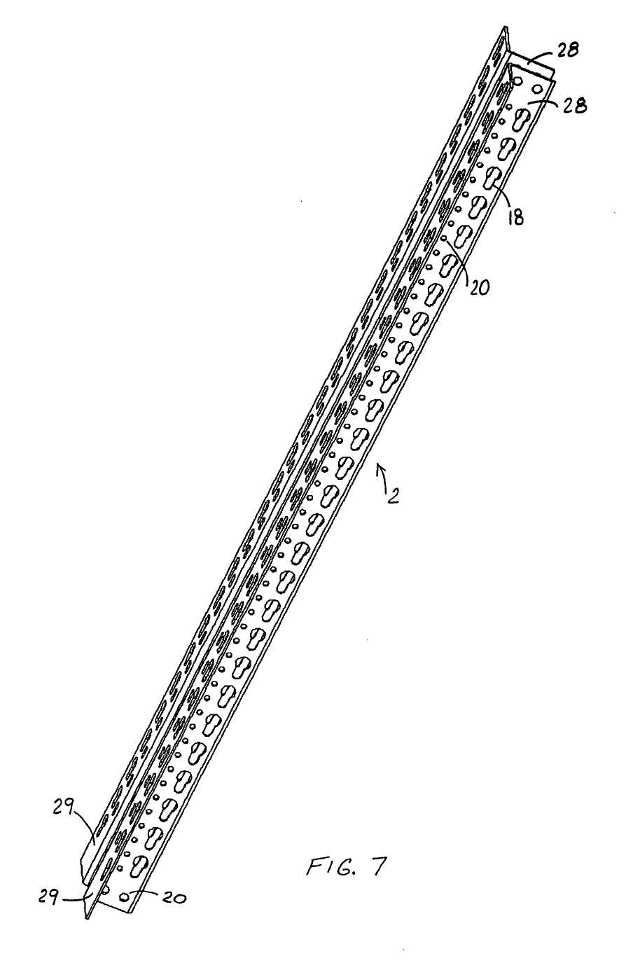

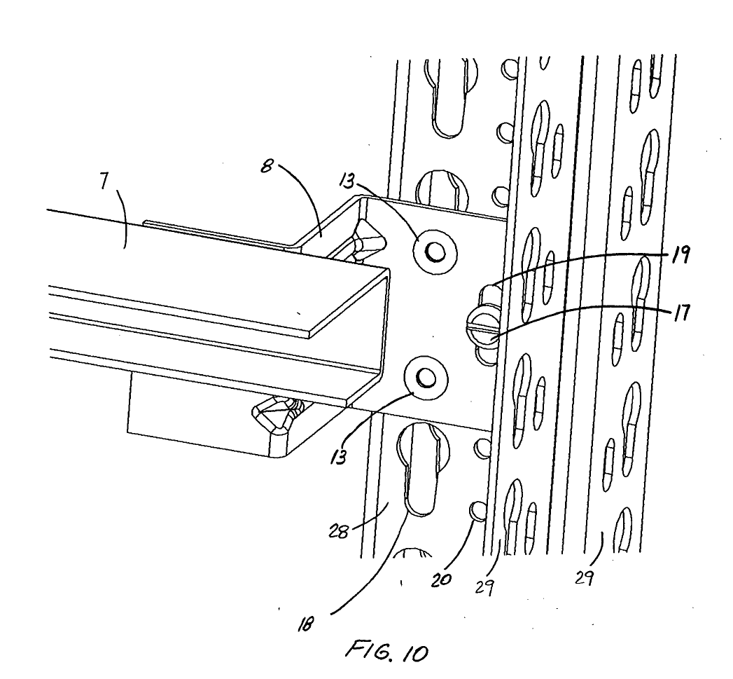

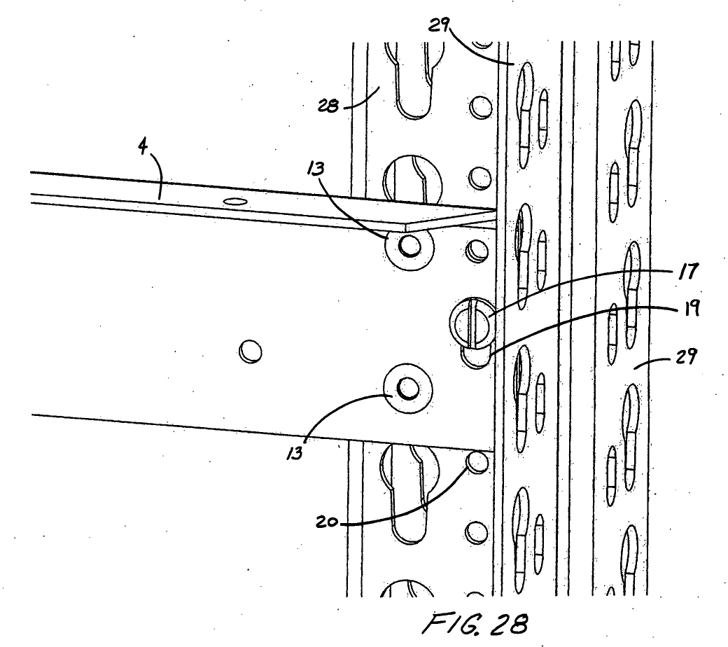

As illustrated in FIGS. 7 and 8, the leg vertical member 2 has two adjacent lateral mounting surfaces 28 and two outward facing mounting surfaces 29. The leg adjacent lateral mounting surfaces 28 contain a repetitive pattern of paired teardrop shaped holes and round holes. As detailed in FIGS. 10 and 28 respectively, a pair of shoulder rivets 13 on rail assemblies 23 and short brackets 4 mate into a pair of adjacent teardrop shaped holes 18 on the leg adjacent lateral mounting surfaces 28. To positively secure each short bracket 4 and rail assembly 23 to the leg adjacent lateral mounting surfaces 28, a screw 17 is inserted through a slot 19 on the short bracket 4 and rail assembly 23 and into the corresponding round hole 20 on the leg adjacent lateral mounting surfaces 28. The alignment of the round hole 20 in the leg adjacent lateral mounting surface 28 relative to the slot 19 in the rail assembly 23 is centered within the slot 19 when the shoulder rivets 13 in the rail assembly 23 are completely nested in the bottom of the teardrop shaped holes 18 in the leg vertical member 2. This concept enables a screw 17 to be installed through the slot 19 to round hole 20 interface even when the shoulder rivets 13 on the rail assemblies 23 are not fully nested into the bottom of the teardrop shaped hole 18 on the leg adjacent lateral mounting surface. Centering the round hole 20 in the leg adjacent lateral mounting surface 28 relative to the slot 19 in the rail assembly's Z-bracket 8 upon full nesting of the shoulder rivets 13 in the rail assembly 23 into the teardrop shaped holes 18 in the leg vertical member 2, enables the identical rail assembly 23 to be used on either the right or left side of the installed drawer 9.

As depicted in FIG. 28, the alignment of the round hole 20 in the leg adjacent lateral mounting surface 28 relative to the slot 19 in the short bracket 4 is towards the top of the slot 19 when the shoulder rivets 13 in the short bracket 4 are fully nested in the bottom of the teardrop shaped holes 18 in the leg adjacent lateral mounting surface 28. This concept enables a screw 17 to be installed through the slot 19 to round hole 20 interface even when the shoulder rivets 13 on the short bracket 4 are not fully nested into the bottom of the teardrop shaped hole 18 on the leg adjacent lateral mounting surface 28.

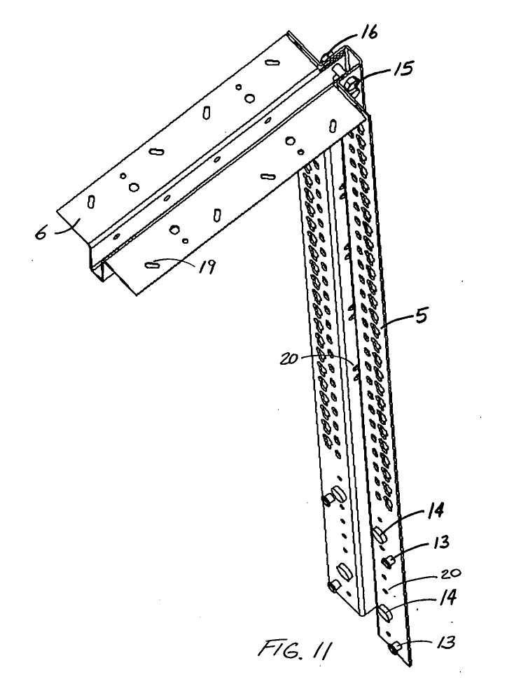

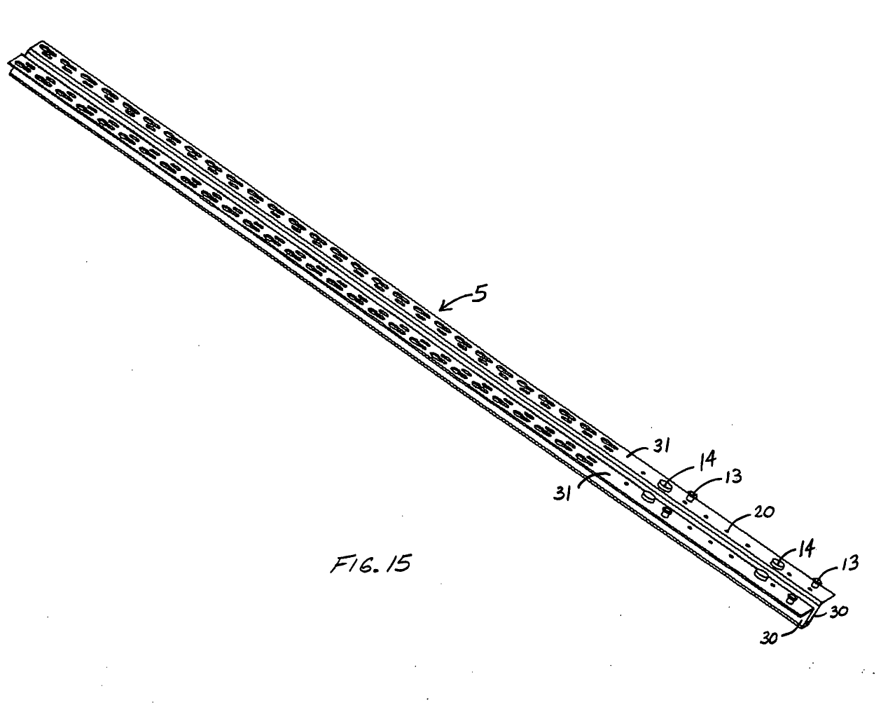

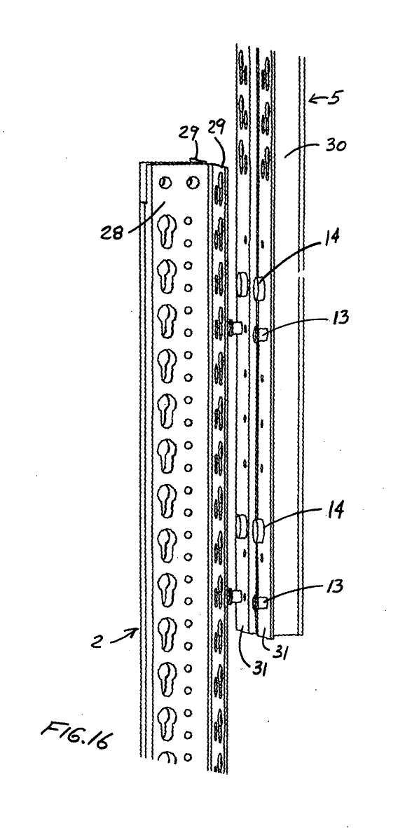

As illustrated in FIGS. 11 and 15, the shelf vertical member 5 has two adjacent lateral mounting surfaces 30 and two outward facing mounting surfaces 31. The shelf vertical member adjacent lateral mounting surfaces 30 contain a repetitive pattern of paired round holes 20. The shelf vertical outward facing mounting surfaces 31 contain a repetitive pattern of paired teardrop shaped holes 18 and slots 19 for the majority of its length and pairs of shoulder rivets 13, spacers 14 and round holes 20 located near the end of the shelf vertical member 5 that mates to the leg vertical member 2. As detailed in FIGS. 16, 17 and 18, the combination of shoulder rivets 13 and spacers 14 enables the shelf vertical member outward facing mounting surfaces 31 to mate-offset to the leg vertical member outward facing mounting surface 29 when inserting pairs of shoulder rivets 13 on the shelf vertical member outward facing mounting surface 31 into the teardrop shaped holes 18 in the leg vertical member outward facing mounting surfaces 29 and achieving contact between the exposed face of the spacers 14 and the vertical member outward facing mounting surface 29. The spacers 14 are sized in thickness to provide a gap between the leg vertical member outward facing mounting surface 29 and the shelf vertical member outward facing mounting surface 31.

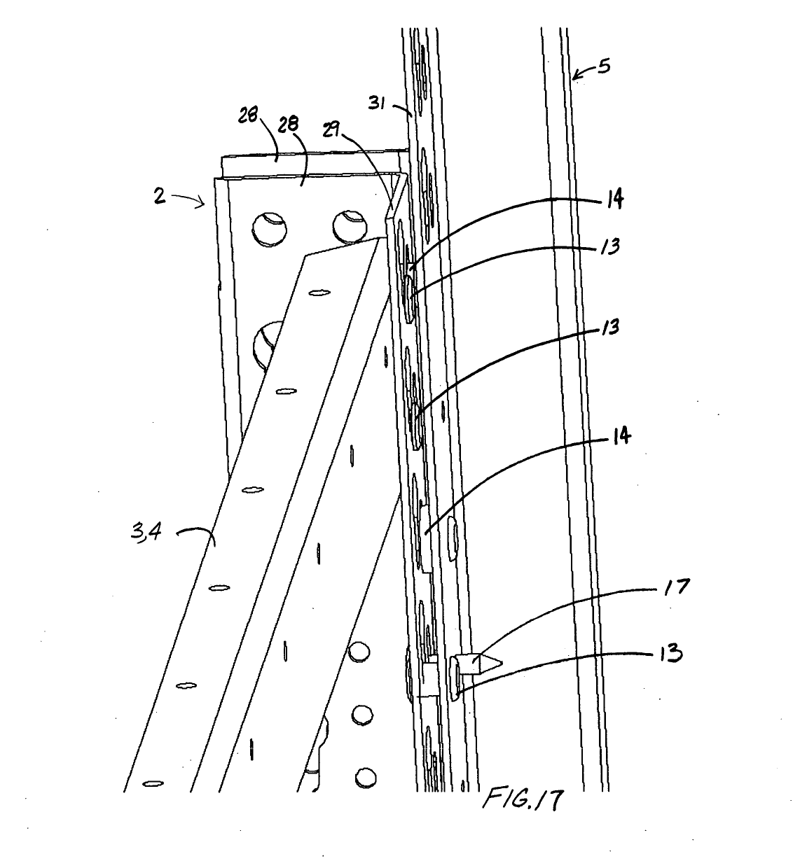

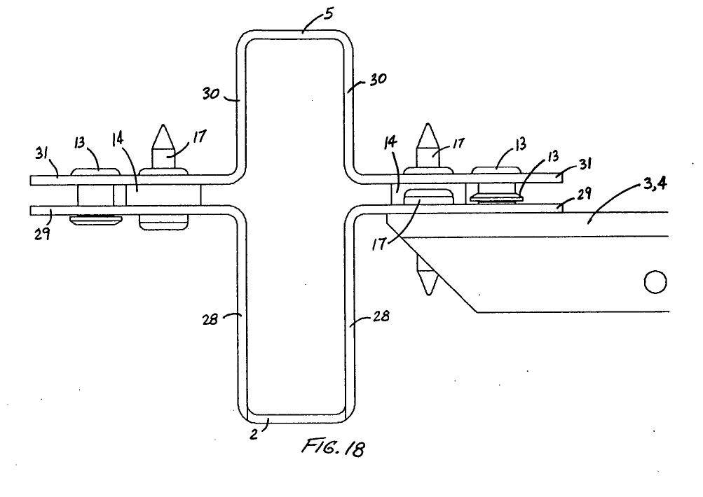

As illustrated in FIGS. 17 and 18, this above described gap provides clearance for the insertion of shoulder rivets 13 on long brackets 3 and short brackets 4 when the long brackets 3 and short brackets 4 are installed onto the leg vertical member outward facing mounting surface 29. To positively secure the shelf vertical member 5 to the leg vertical member 2, a screw 17 is inserted through a slot 19 in the leg vertical member outward facing mounting surface 29 and into a corresponding round hole 20 in the shelf vertical member outward facing mounting surface 31. As shown in FIG. 17, the alignment of the round hole 20 in the shelf vertical member outward facing mounting surface 31 relative to the slot 19 in the leg vertical member outward facing mounting surface 29 is towards the bottom of the slot 19 when the shoulder rivets 13 in the shelf vertical member outward facing mounting surface 31 are completely nested in the bottom of the teardrop shaped holes 18 in the leg vertical member outward facing mounting surface 29. This concept enables a screw 17 to be installed through the round hole 20 to slot 19 interface should the shoulder rivets 13 on the shelf vertical member outward facing mounting surface 31 not fully nest into the bottom of the teardrop shaped holes 18 on the leg vertical member outward facing mounting surface 29.

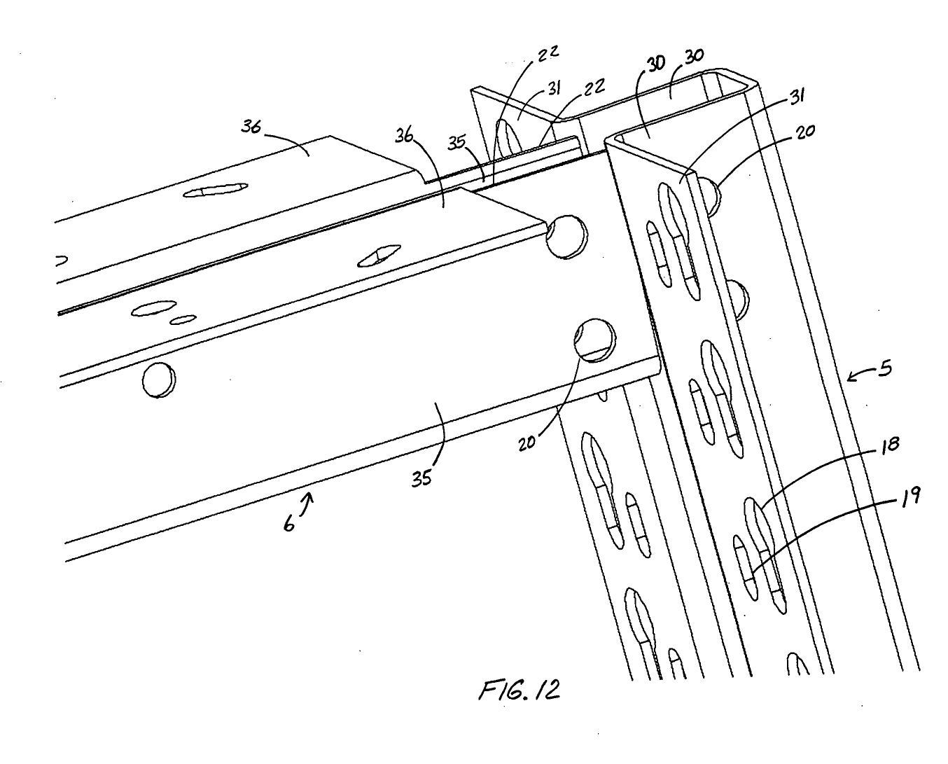

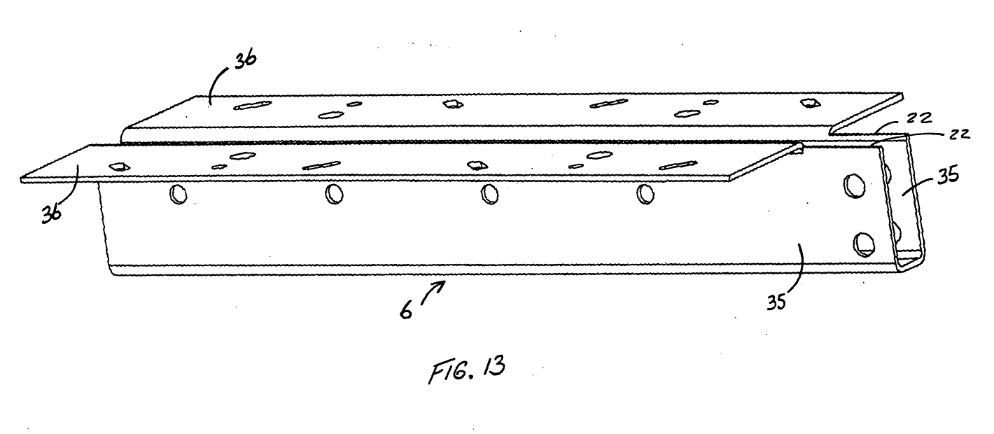

As depicted in FIGS. 11, 12 and 13, the upper shelf assembly 25 is comprised of a shelf vertical member 5 and a shelf horizontal member 6 bolted together by a pair of bolts 15 at their nested interface. FIG. 12 illustrates how cut-outs 22 in the shelf horizontal member outward facing mounting surfaces 36 enable it to mate flush to the shelf vertical member adjacent lateral mounting surfaces 30. The repetitive pattern of paired round holes 20 on the shelf vertical member adjacent lateral mounting surfaces 30 accept bolts 15 for fastening one or more shelf horizontal members 6 at varying heights. As detailed in FIGS. 2 and 11, the shelf horizontal member 6 has a unique hole pattern on its top surface and is sized in length to accept the fastening of an integer number of dimensional wood pieces 10 spanning its top surface or accepts the fastening of twice as many dimensional wood pieces 10 forming a butt joint 41 at the centerline of its cross section.

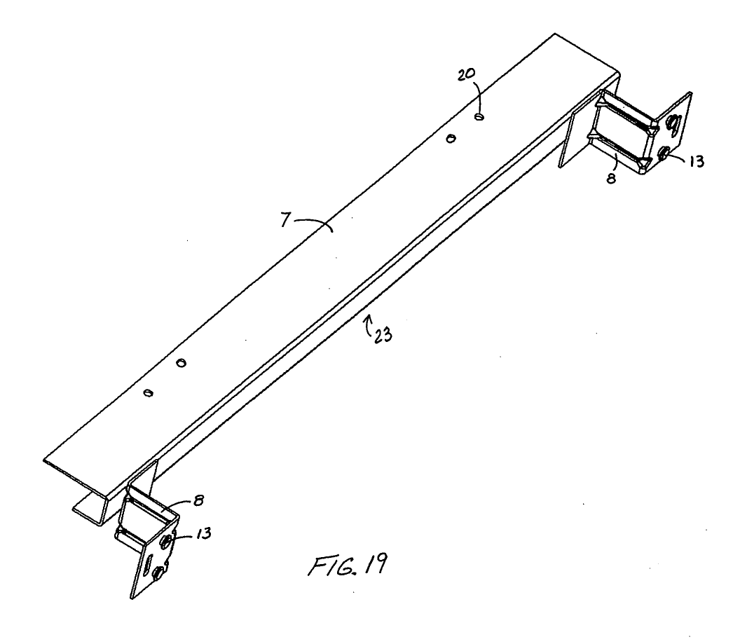

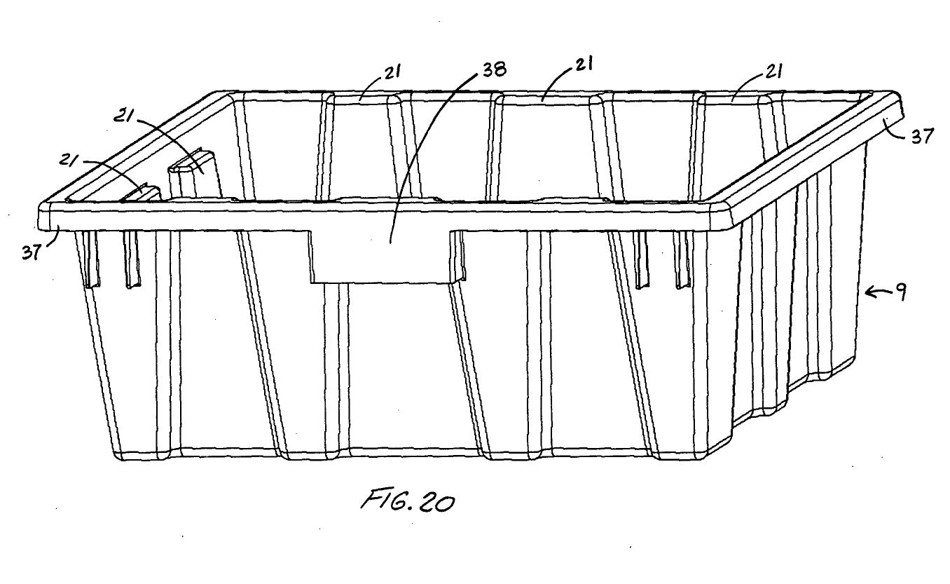

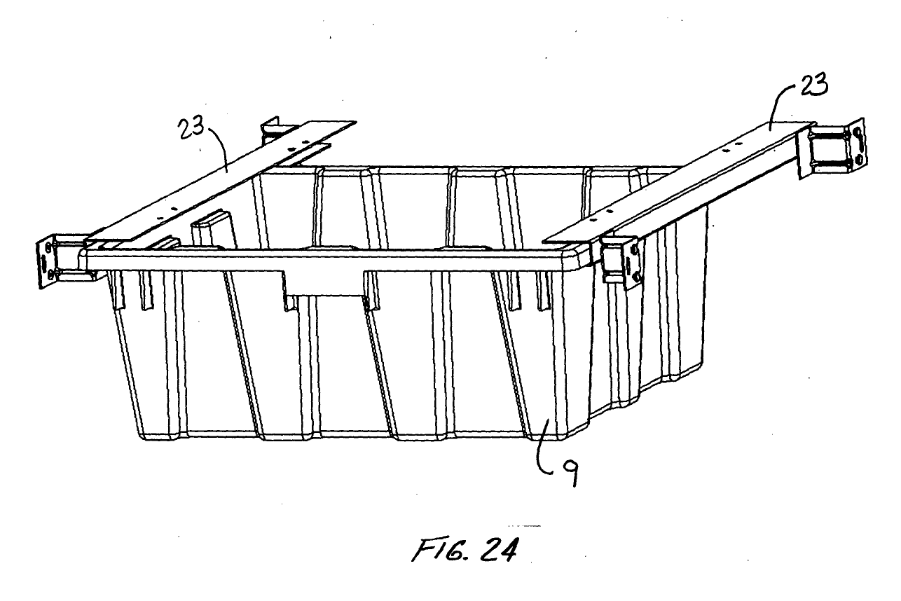

FIG. 20 illustrates a plastic injected drawer 9 with a 360 degree lip 37 located around its top surface, handles 38 on its front and rear surfaces, and stiffening protrusions 21 that that extend the full height of the drawer on the forward and rear surfaces of the drawer, and stiffening protrusions 21 that extend from the bottom of the drawer 9 to a specified distance less than the top of the drawer 9 on the drawer side surfaces. This specified distance provides the required clearance for an installed pin 12 on a rail assembly 23 to move across the width of the drawer 9 and act as a drawer stop. By recessing the stiffening protrusions 21 on the side of the drawer 9, the channel 7 top surface can be minimized in length thereby reducing part cost and weight. FIG. 24 illustrates how the drawer 9 is inserted into a pair of rail assemblies 23. Each rail assembly 23 consists of a channel 7 welded to two Z-brackets 8 as shown in FIG. 19.

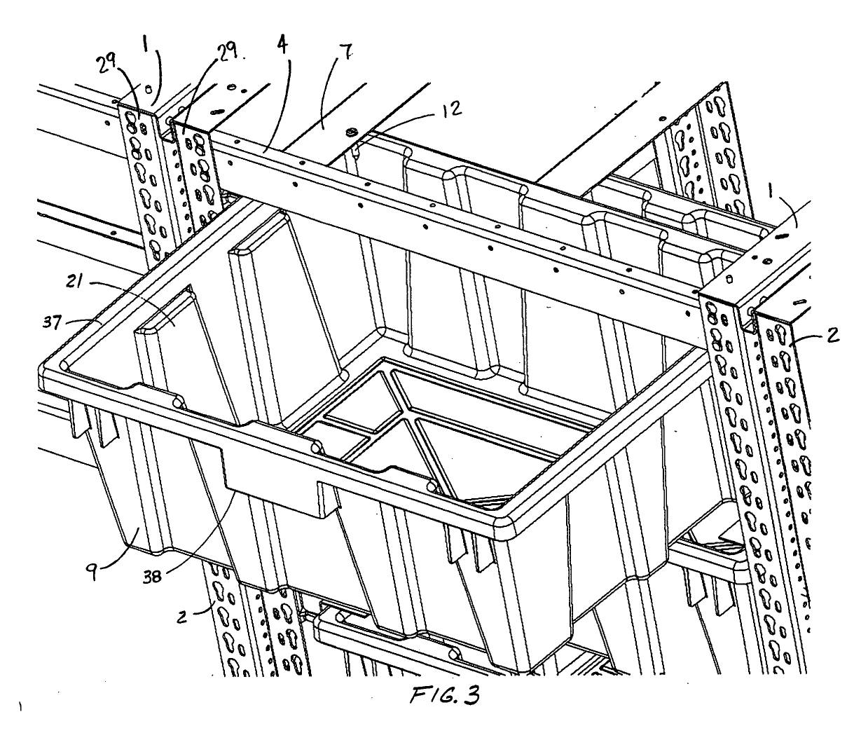

FIGS. 3 and 19 illustrate how the center portion of the Z-bracket 8 is sized in length to provide clearance between the outward face of the lip 37 on the sides of the drawer 9 and the outward edge of the leg vertical member outward facing mounting surface 29 when the drawer 9 is installed into the assembled workbench. The recessed webbing 21 on the side surfaces of the drawer 9 allow the required length of the channel's 7 top surface to be minimized for cost savings. Per FIGS. 3 and 19, the channel's top surface contains a set of round holes 20 whereby pins 12 are installed into the selected holes and catch the interior forward and rear surfaces of the drawer 9 resulting in a drawer stop. These round holes 20 located symmetrically from each end of the channel 17 permits the rail assembly 23 to be used on either the right or left side of the drawer.

As depicted in FIGS. 1, 23 and 26, the short bracket 4 supports the sides of the long wooden shelves 11; supports the front, back and sides of the short wooden shelves 26; provides the required spacing between leg vertical members 2 for installation of the drawers 9; and when flipped upside down and installed on the rear facing surfaces of the shelf vertical member's outward facing mounting surfaces 31, serve as a small bin support spanning two shelf vertical members 5 located either above a short wooden shelf 26 or a set of drawers 9.

As shown in FIG. 26, the long bracket 3 supports the front and rear of the long shelves 11 and provides the required spacing between the leg vertical members 2 for the long shelves 11 cut to a specified length. As shown in FIG. 25, when flipped upside down and installed on the rear facing surface of the shelf vertical member 5 outward facing mounting surfaces 31, the long bracket 3 serves as a small bin 27 support spanning two shelf vertical members 5, located above a long shelf.

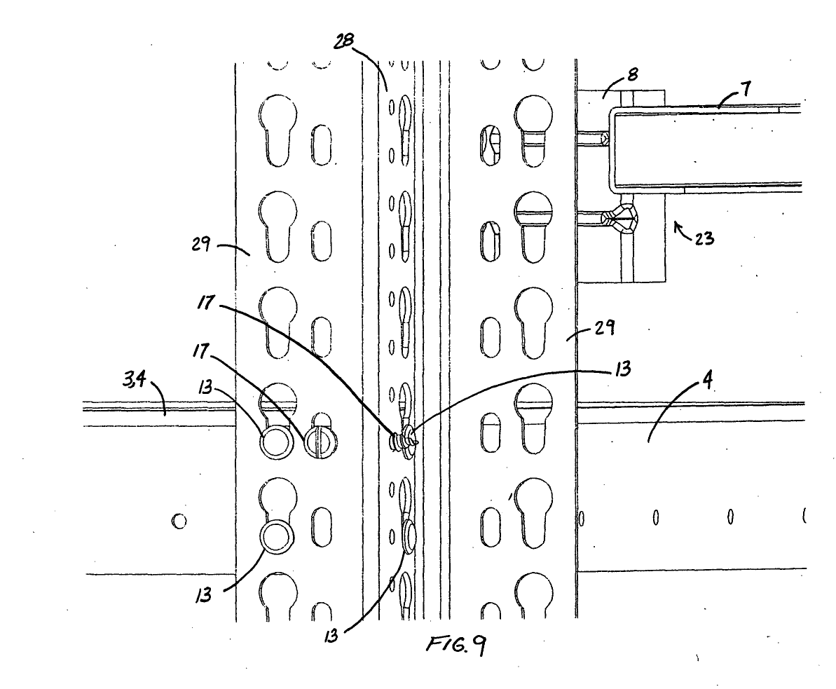

As illustrated in FIG. 9, when used to support shelves on the front and rear of the workbench, or provide required lengthwise spacing between leg vertical members 2, the short brackets 4 and long brackets 3 are fastened to the leg vertical member outward facing mounting surfaces 29 by inserting a pair of shoulder rivets 13 on the short brackets 4 and long brackets 3 into a pair of adjacent teardrop shaped holes 18 on the leg vertical member outward facing mounting surfaces 29. To positively secure each short bracket 4 and long bracket 3 to the leg vertical member outward facing mounting surfaces 29, a screw 17 is inserted through a slot in the leg vertical member outward facing mounting surfaces 29 and into a corresponding round hole 20 in the short brackets 4 and long brackets 3. The alignment of the round hole 20 in the short brackets 4 and long brackets 3 relative to the slot 19 in the leg vertical member 2 is towards the bottom of the slot 19 when the shoulder rivets 13 in the short brackets 4 and long brackets 3 are fully nested in the bottom of the teardrop shaped holes 18 in the leg vertical member outward facing mounting surfaces 29. This concept enables a screw 17 to be installed through the round hole 20 to slot 19 interface even when the shoulder rivets 13 on the short brackets 4 and long brackets 3 are not fully nested into the bottom of the teardrop shaped hole 18 on the leg vertical member outward facing mounting surfaces 29.

As depicted in FIG. 28, when used in the lateral direction to support long wooden shelves 11 and short wooden shelves 26, the short brackets 4 are fastened to the leg vertical member adjacent lateral mounting surfaces 28 by inserting a pair of shoulder rivets 13 in the short brackets 4 into a pair of adjacent teardrop shaped holes 18 on the leg vertical member adjacent lateral mounting surfaces 28. To positively secure the short bracket 4 to the leg vertical member adjacent lateral mounting surfaces 28, a screw 17 is installed through a slot 19 in the short bracket 4 into a corresponding round hole 20 in the leg vertical member adjacent lateral mounting surfaces 28. The alignment of the round hole 20 in the leg vertical member adjacent lateral mounting surfaces 28 relative to the slot 19 in the short bracket 4 is towards the top of the slot 19 when the shoulder rivets 13 in the short bracket 4 are fully nested in the bottom of the teardrop shaped holes 18 in the leg vertical member adjacent lateral mounting surfaces 28. This concept enables a screw 17 to be installed through the slot 19 to round hole 20 interface even when the shoulder rivets 13 on the short brackets 4 are not fully nested into the teardrop shaped holes 18 in the leg vertical member adjacent lateral mounting surfaces 28.

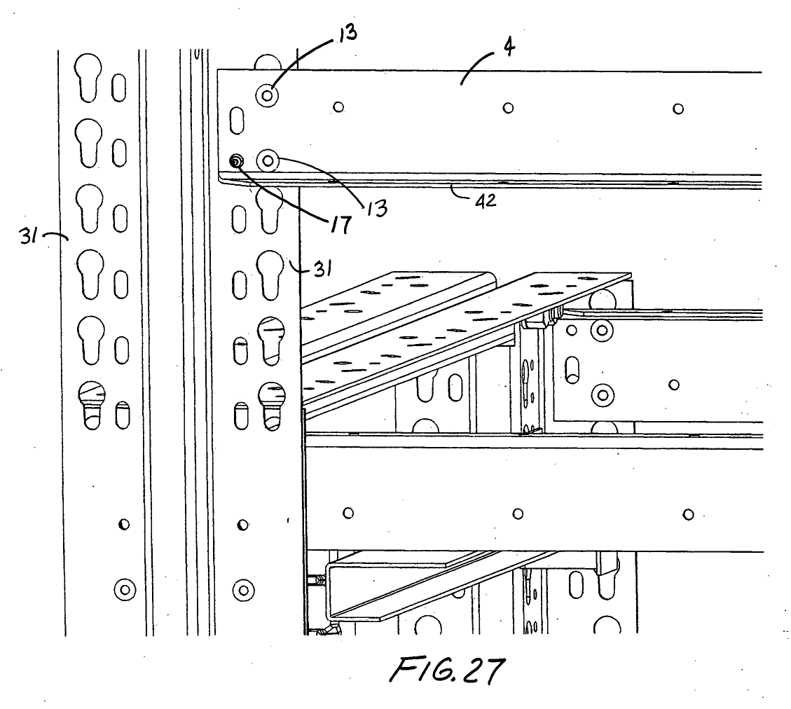

As illustrated in FIG. 27, when used as a small bin 27 support, the short bracket flange 42 is orientated downward and pointed in the rear direction. This orientation of the small bracket 4 enables the small bins 27 to be secured to its upward facing surface. To positively secure each short bracket 4 to the shelf vertical member outward facing mounting surfaces 31, a screw 17 is inserted through a slot 19 in the shelf vertical member outward facing mounting surfaces 31 and into a round hole 20 in the short bracket 4. The alignment of the round hole 20 in the short bracket 4 relative to the slot 19 in the shelf vertical member outward facing mounting surfaces 31 is towards the bottom of the slot 19 when the shoulder rivets 13 in the short bracket 4 are completely nested in the bottom of the teardrop shaped holes 18 in the shelf vertical member 5. This concept enables a screw 17 to be installed through the slot 19 to round hole 20 interface even when the shoulder rivets 13 on the short brackets 4 are not fully nested into the bottom of the teardrop shaped holes 18 on the shelf vertical member outward facing mounting surfaces 31.

The leg horizontal member 1, when located at the bottom of the leg assembly 24, can be lag-bolted to the floor through its pre-drilled holes, or casters can easily be mounted to this surface.

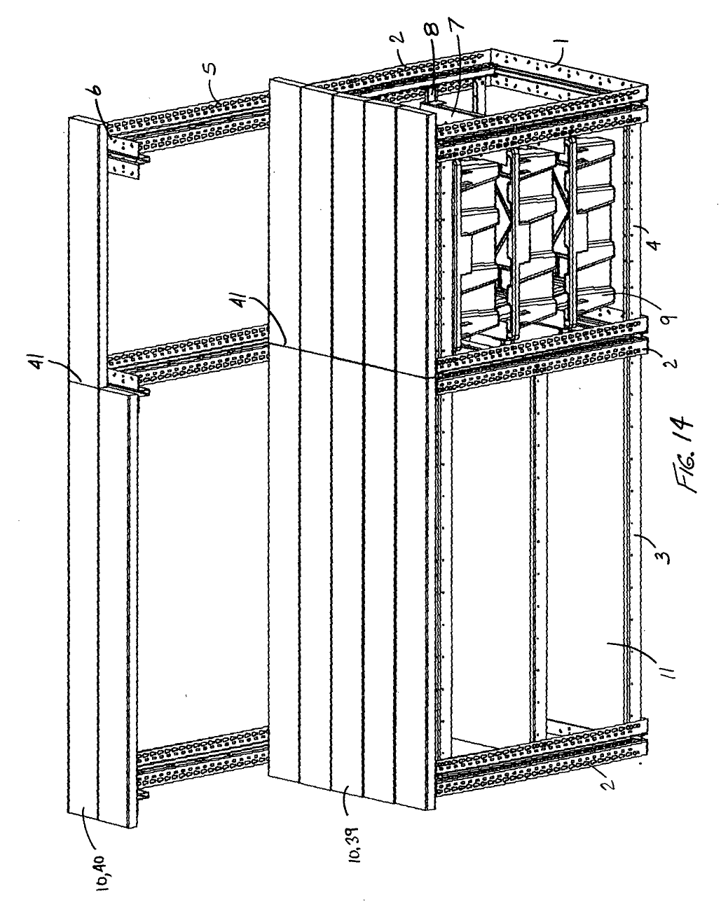

As depicted in FIG. 14, the unique upper shelf assembly 25 enables an integer number of dimensional lumber pieces 10 to span and fasten to its top surface or allows the fastening of twice as many dimensional lumber pieces 10 to form a butt joint at the centerline of its cross section. The dimensional lumber pieces 10 are fastened to the shelf horizontal member outward facing mounting surfaces 36 by inserting wood screws through the pre-drilled holes in the shelf horizontal member outward facing mounting surfaces 36 into the dimensional lumber pieces 10.

FIG. 23 depicts another potential workbench configuration with a set of long wooden shelves 11 and a set of short wooden shelves 26. The long wooden shelves 11 and short wooden shelves 26 are fastened to the forward and rear positioned long brackets 3 and short brackets 4 by installing wood screws through the pre-drilled holes in the flanged surface of the long brackets 3 and short bracket 4 and into the dimensional lumber pieces 10.

1. A leg assembly consisting of a horizontal top member of U-shaped cross section with a pair of flanges attached to a top end thereof, said flanges protruding in opposite outward directions from a central vertical axis of the member; and a horizontal bottom member of U-shaped cross section with a pair of flanges attached to a top end thereof, said flanges protruding in opposite outward directions from a central vertical axis of the bottom member; that nest into localized cutouts in the center of the ends of two vertical members, also of U-shaped cross section with a pair of flanges attached to a top end thereof, said flanges protruding in opposite outward directions from a central vertical axis of the vertical members; and are mechanically fastened together at their adjacent mating surfaces, to form a rectangular frame structure, with each of said outward protruding flanges orientated outboard of the center of the said frame assembly.

2. A shelf assembly consisting of a horizontal member of U-shaped cross section with a pair of flanges attached to a top end thereof, said flanges protruding in opposite outward directions from a central vertical axis of the member, with said outward protruding flanges locally removed from one end of the said horizontal member; said horizontal member nests into the center of a vertical member of U-shaped cross section with a pair of flanges attached to a top end thereof, said flanges protruding in opposite outward directions from a central vertical axis of the member, by inserting the end of the said horizontal member with said removed outward protruding flanges into the central opening of the said vertical member, and are mechanically fastened together at their adjacent mating surfaces to form an L-shaped support assembly, with the said outward protruding flanges of the said horizontal member orientated upward.

3. A shelf assembly as in claim 2, further comprising:
a horizontal member with each of said outward protruding flanges having a plurality of predrilled holes and said horizontal member sized in length, front to rear, to accept the fastening of an integer number of like pieces of a specified size of standard dimensional lumber spanning its top surface; said horizontal member to accept the fastening of twice as many of said integer number of like pieces of a specified size of standard dimensional lumber pieces forming a butt joint at the central vertical axis of the horizontal member.

4. A shelf assembly as in claim 2, further comprising:
a shelf vertical member with installed spacers and protruding shoulder rivets on its outward protruding flanges, with manufactured heads of said spacers and protruding shoulder rivets located outboard of the member's surfaces, that is assembled to a leg vertical member by placing the said manufactured heads of the said shoulder rivets into the said vertical leg's teardrop hole pattern and in doing so, the said spacers ensure a mate offset condition, equivalent to the width of the said spacers, between the opposing said outward protruding flanges of the shelf vertical member and the said outward protruding flanges of the leg vertical member; said gap achieving the required clearance necessary for installing additional components, that also incorporate shoulder rivets, onto the said outward protruding flanges of the leg vertical member without the need of removing the shelf vertical member.

5. A dual-purpose support bracket of L-shaped cross section, containing a pair of shoulder rivets located towards each end of the longer flanged surface; said bracket serves as a shelf support when the short flanged surface is orientated upward and the said bracket is attached to leg members; said bracket serves as a small bin support when the said short flanged surface is located downward and said bracket is attached to vertical shelf members.

6. A rail assembly consisting of a J-shaped cross section channel, with longest surface of said cross section orientated upward, has two extension brackets welded to the outboard surface of the center surface of the said cross section, said extension brackets located toward each end of the said channel; said extension brackets each containing three surfaces, two that are parallel to each other and a connecting surface; said extension brackets containing a pair of installed shoulder rivets on a surface outboard and parallel to the said welded surface of the extension bracket; said shoulder rivets enable the rail assembly to be attached to a leg vertical member by placing the said shoulder rivets into a teardrop shaped hole pattern on the said vertical leg; said extension bracket sized in length between its said welded surface and the said outboard parallel surface to provide sufficient spacing such that the side of a drawer will not contact the outboard edge of a vertical leg member; said rail assembly be fully interchangeable for use on the right side or left side of a drawer.

7. A J-shaped cross section channel as in claim 6, further comprising:
the addition of holes on the longest surface of said cross section that accept a pair of pins when the said channel is assembled as part of a drawer rail assembly; said forward located pin acting as a drawer stop contacting the rear inboard surface of a drawer to stop outward drawer motion, and said rear located pin acting as a drawer stop contacting the rear outboard surface of a drawer to stop inward drawer motion; said rail assembly be fully interchangeable for use on the right side or left side of a drawer.

8. A plastic injected drawer with a 360 degree lip located around its top surface, and stiffening protrusions that that extend the full height of the drawer on the forward and rear surfaces of the drawer, and stiffening protrusions that extend from the bottom of the drawer to a specified distance less than the top of the drawer on the drawer side surfaces; said distance permits clearance of an installed pin on a rail assembly that acts as a draw stop.
